(19) United States
(12) Patent Application Publication
(10) Pub. No.: US 2012/0058694 A1
(43) Pub. Date: Mar. 8, 2012

(54) Rudder Propeller Vessel Propulsion System and Vessel Equipped Therewith and Assembly and Disassembly Method Therefor

(75) Inventor: Gerd Krautkramer, Spay/Rhein (DE)

(73) Assignee: SCHOTTEL GMBH, Spay/Rhein (DE)

(21) Appl. No.: 13/320,209

(22) PCT Filed: May 12, 2010
(86) PCT No.: PCT/DE10/00525

§ 371 Date: Nov. 11, 2011

(30) Foreign Application Priority Data
May 28, 2009 (DE) 202009007589.3

(51) Int. Cl. B63H 5/125; B23P 11/00

(52) U.S. Cl. 440/51; 29/889.1

(57) ABSTRACT

A rudder propeller ship propulsion system with a rudder propeller containing an underwater housing mounted on a receiver that is detachably fastened on or in a ship's hull has locks for the receiver separate from a fastener whereby the receiver can be locked and unlocked on or in the hull even when the fastener is released. The rudder propeller ship propulsion system is disassembled from the ship by releasing the fastener so that the receiver is only held on or in the ship by the locks, and then the locks are unlocked at locking sites between the receiver and ship so that the receiver and rudder propeller can be removed.

The present inventions pertains to a rudder propeller ship propulsion system and a ship equipped therewith as well as an assembly and disassembly process therefor.

For maintenance and repair purposes in particular, rudder propellers of corresponding ship propulsion systems have to be removed, which is basically very costly since a rudder propeller contains an underwater housing arranged below a ship's hull, such as, preferably, a gondola, and thus, is under water so that it has to be disassembled and taken out of the water for maintenance and repair work. The disassembly and later the assembly under water alone already represent very complicated and costly tasks, or a ship equipped with such a rudder propeller propulsion system has to be lifted out of the water to get at the rudder propeller, which is also terribly expensive.

The present invention has and achieves the goal of improving a rudder propeller ship propulsion system and a ship with it as well as assembly and disassembly process therefor, especially as regards improving the maintenance and repair friendliness.

For this purpose, the present invention provides a rudder propeller ship propulsion system with a rudder propeller, which contains an underwater housing and is installed and/or mounted on a receiving means that can be detachably fastened by fastening means on or in a ship's hull, wherein locking means are also provided for the receiving means, which are separate with respect to the fastening means and wherein the receiving means can be locked and unlocked by the locking means on or in a ship's hull even when the fastening means are released.

The present invention also provides a ship with a rudder propeller ship propulsion system, which contains a rudder propeller with an underwater housing, which rudder propeller is installed and/or mounted on a receiving means that is detachably fastened by fastening means on or in the hull of a ship, wherein locking means are also provided for the receiving means, which are separate with respect to the fastening means, and wherein the receiving means can be locked and unlocked on or in a ship's hull by the locking means even when the fastening means are released.

Finally, the present invention provides an assembly and disassembly process for a rudder propeller ship propulsion system on or in a ship with a rudder propeller, which contains an underwater housing and is installed and/or mounted on a receiving means that is detachably fastened on or in a ship's hull by means of fastening means, wherein locking means are also provided for the receiving means, which are separate with respect to the fastening means, and wherein the receiving means can be locked or unlocked on or in a ship's hull even when the fastening means are released, in which process for disassembly of the rudder propeller ship propulsion system of or from a ship starting from a state in which the receiving means is fastened by the fastening means on or in the ship and is locked by the locking means on or in the ship, first the fastening means are released, so that the receiving means is only held on or in the ship by the locking means and then the locking means are unlocked free of manual work at the locking sites between receiving means and ship, so that the receiving means plus rudder propeller can be removed.

The separation between the fastening means, on the one hand, and locking means, on the other hand, has several advantages. On the one hand, the fastening means can be specifically matched to the requirements for fastening the receiving means plus rudder propeller during operation of the rudder propeller ship propulsion system, while the locking means are configured such that they hold the receiving means plus rudder propeller only during assembly and disassembly work on or in the ship. Due to the fact that the unlocking, at any rate, but preferably also the locking of the locking means are accomplished free of manual work at the locking sites between receiving means and ship, on the other hand, any corresponding process is possible simply and economically even under water or with water penetrating in. For example, the release of the fastening means can thus be accomplished without problems by manual work without requiring underwater work or hoisting of the ship out of the water, and the unlocking of the locking means is then accomplished without manual effort at the unlocking sites such as, e.g., by corresponding mechanisms or automatic devices.

Advantageous variants of rudder propeller ship propulsion, a ship equipped with it and assembly and disassembly process for it contain:

a main motor of the rudder propeller ship propulsion system is preferably removable by means of a framing means in a ship equipped with the rudder propeller ship propulsion system according to the present invention and especially installable or installed so as to be removed upwards, wherein the main motor and the framing means are preferably separated and removable from the ship in succession in this order;

a control gear for the rudder propeller ship propulsion system is installable or installed so as to be removable in a ship equipped with the rudder propeller ship propulsion system according to the present invention and especially removable upwards and positioned, to be sure, between the or a main motor of the rudder propeller ship propulsion system and the receiving means, wherein it is especially preferred for the control gear of the rudder propeller ship propulsion system to be removable from the ship together with the receiving means and wherein even more preferred for a covering to be provided for the control gear of the rudder propeller ship propulsion system in order to be positioned on the receiving means before the unlocking of the locking means and tightly sealed over the control gear;

an elastic shaft is provided for transmitting movement and torque between the or a main motor of the rudder propeller ship propulsion system and the or a control gear of the rudder propeller ship propulsion system and especially after a removal of the main motor and before a removal of the control gear installable or installed separately in a ship equipped with the rudder propeller ship propulsion system according to the present invention in a removable manner and especially removable upwards;

the locking means are unlocked during the operation of the ship and are only locked for disassembly of the rudder propeller ship propulsion system at the latest before the release of the fastening means;

sealing means are provided between the ship and rudder propeller ship propulsion system, especially its receiving means and are especially active until the release of the locking means to keep water away from them, in order to pass into the ship's interior when the rudder propeller ship propulsion system is installed on the receiving means;

an assembly room for the rudder propeller ship propulsion system is preferably flooded in the ship before or after the unlocking of the locking means; and

a sealing plate is installable in a sealing manner at the site of the receiving means after removal of the rudder propeller ship propulsion system from the ship in an assembly room of the rudder propeller ship propulsion system, and water is especially preferably pumped out of the assembly room of the rudder propeller ship propulsion system in the ship after installation of the sealing plate.

Other preferred and/or advantageous embodiments of the present invention are disclosed by the claims and their combinations as well as the entire set of present application documents.

The present invention is explained below in detail based on exemplary embodiments with reference to the drawing given solely by way of example, in which

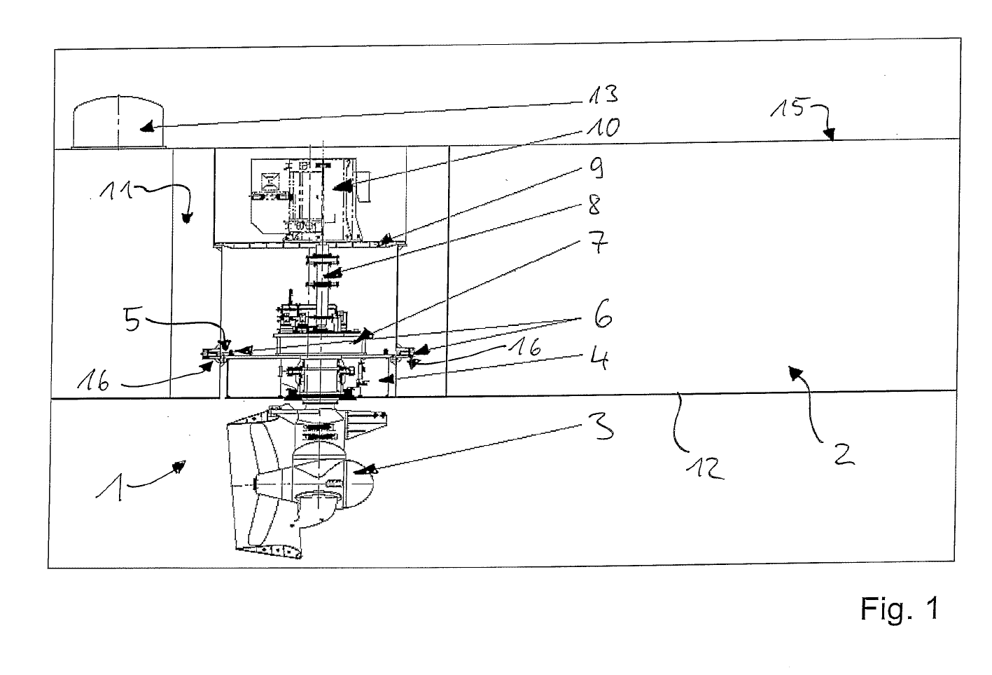

FIGS. 1 through 11 illustrate in schematic partial views the components of the rudder propeller ship propulsion system in the ship and process steps in the disassembly of the rudder propeller ship propulsion system from the ship based on an exemplary embodiment.

Based on the exemplary embodiment and application described below and shown in the drawing, the present invention is explained in detail solely by way of example, i.e., it is not limited to this exemplary embodiment and application or to the combinations of features within this exemplary embodiment and application. Process and device features are also to be disclosed, respectively, in a similar manner from the device and process descriptions.

Individual features that are indicated or shown in connection with a specific exemplary embodiment are not limited to this exemplary embodiment or the combination with the other features of this exemplary embodiment, but rather may be combined, within the scope of the technically possible, with any other variants even if they are not discussed separately in the present documents.

The same reference numbers in the individual figures and illustrations of the drawing refer to the same or similar or identically or similarly acting components. Based on the views in the drawing, such features that are not provided with reference numbers also become clear regardless of whether such features are described below or not. On the other hand, features that are contained in the present specification but are not visible or shown in the drawing are easily understandable to the person skilled in the art.

FIG. 1 shows schematically a rudder propeller ship propulsion system 1 installed in a ship 2. The rudder propeller ship propulsion system 1 contains a rudder propeller 3, a receiving means 4, fastening means 5, locking means 6, a control gear 7, an elastic shaft 8, framing means 9 and a main motor 10. The rudder propeller ship propulsion system 1 is installed in an assembly room in the hull 12 of the ship 2 in such a way that the receiving means 4 positions the rudder propeller 3 outside the hull 12 of the ship 2, in particular on the bottom of the ship 2. The rudder propeller 3 especially preferably extends below the ship 2 and the receiving means 4 closes the assembly room 11 in the ship 2 against the water, especially at least essentially in a flush manner. In the ship's interior, the receiving means 4 carries the control gear 7 and preferably forms an assembly/disassembly unit with it. The control gear 7 is in active connection via the elastic shaft 8 with the main motor 10 which in turn is held by the framing means 9 in the assembly room 11.

In FIG. 1, a cover 13 is already shown, which is provided to ensure a water-tight encapsulation of the control gear 7 on the receiving means 4 when the assembly room 11, e.g., for disassembly of the receiving means 4 from the ship 2, is flooded together with the control gear 7 and rudder propeller 3.

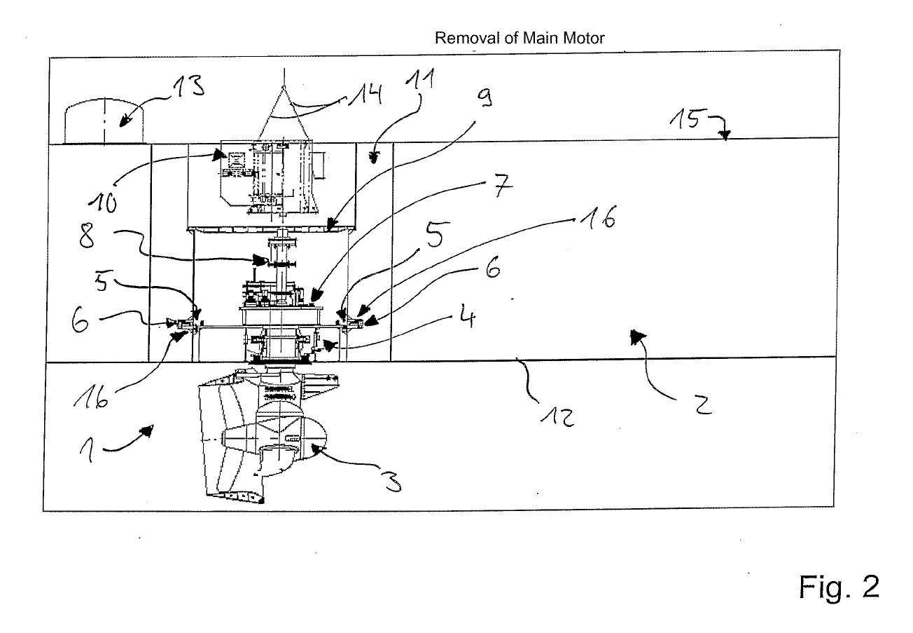

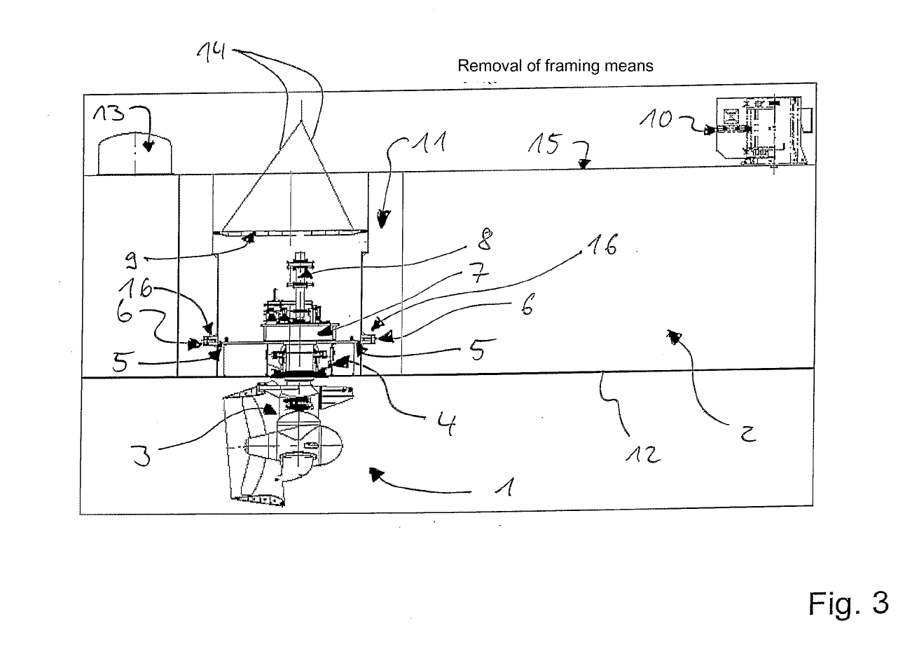

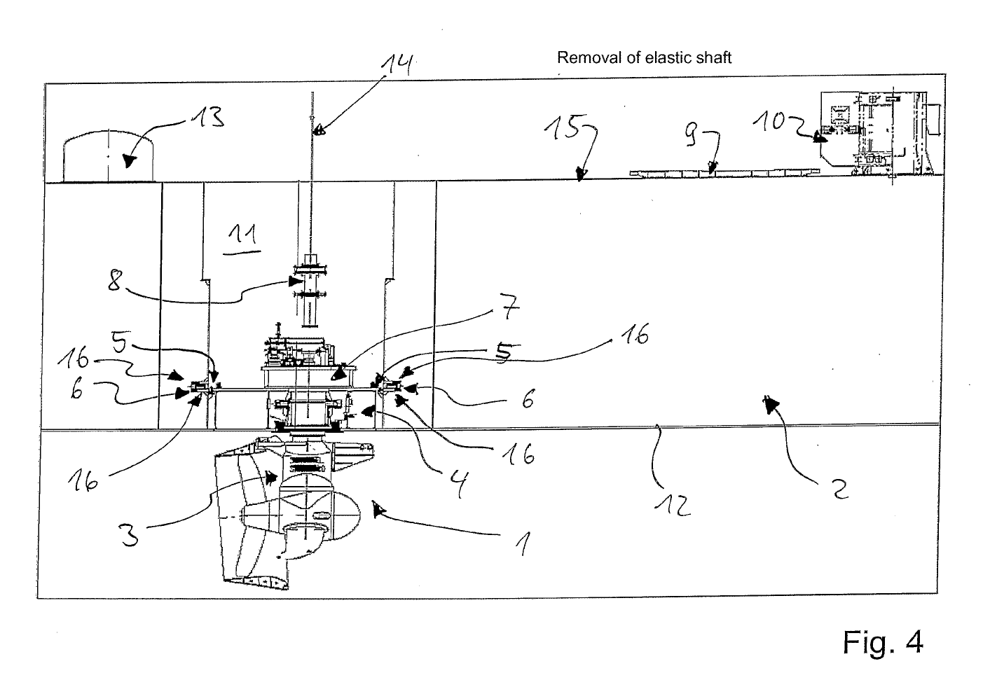

FIG. 2 illustrates how at the beginning of disassembly of the rudder propeller ship propulsion system from the ship 2, at first the main motor 10 is lifted alone, e.g., with a crane (not shown), suspended on cables 14, especially upwards out of the assembly room 11. As can be seen in FIGS. 3 through 11, the main motor 10 is set down, e.g., on the upper deck 15 of the ship 2 and can be maintained or repaired there. After removal of the main motor 10, the framing means 9 are lifted in turn on cables 14 with the crane (not shown) out of the assembly room 11, as illustrated by FIG. 3 and laid down on deck 15 (see from FIG. 4 on).

FIG. 4 shows the step of lifting the elastic shaft 8 out of the assembly room 11 on the cables 14 by the crane (not shown).

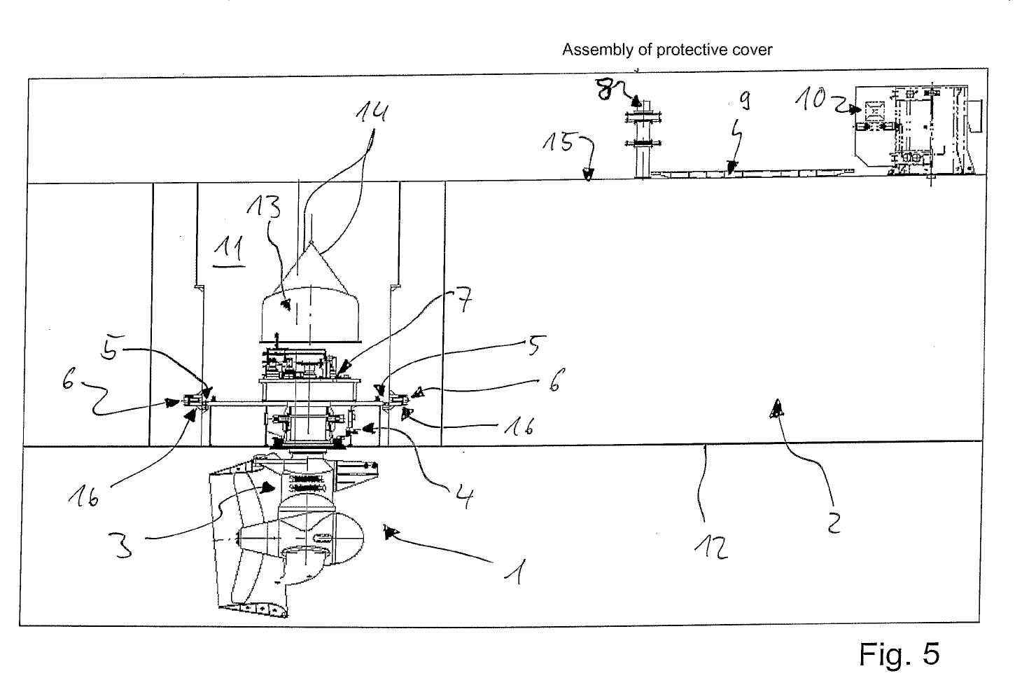

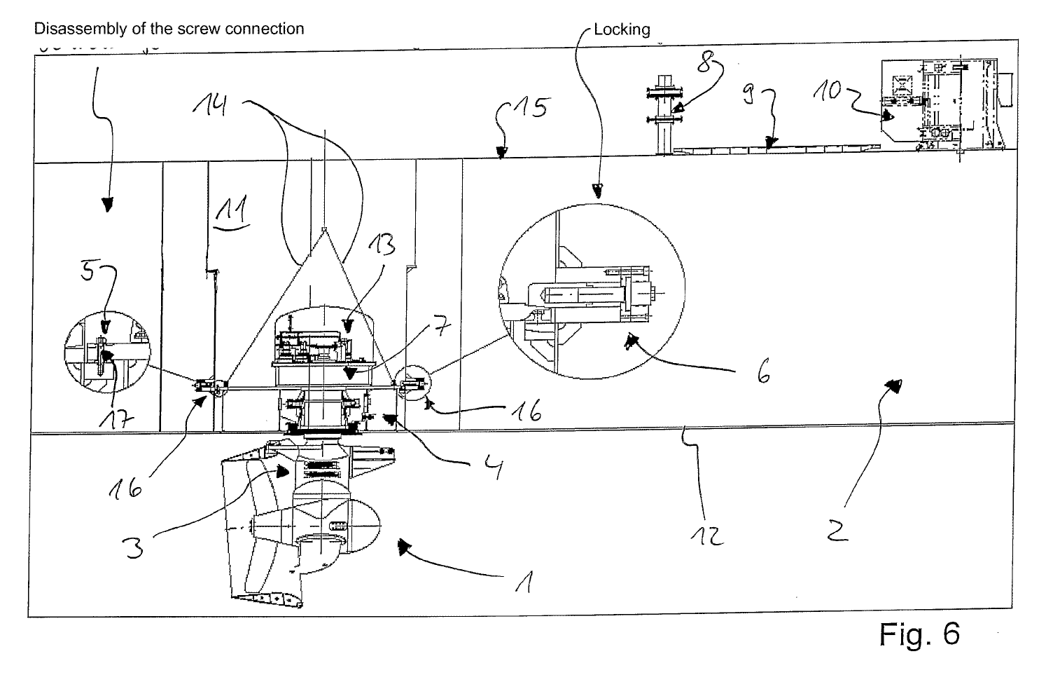

It can be perceived from FIG. 5 that, on the one hand, the elastic shaft 8 is now set down on the upper deck 15 of the ship 2 and can be maintained there, and that, on the other hand, the cover 13 is lifted on the cables 14 by the crane (not shown) into the assembly room 11, so that the cover 13 is placed over the control gear 7 and is fastened to the receiving means 4 for its watertight protection, as FIG. 6 shows.

Furthermore, it can be seen from FIG. 6 that the locking means 6 are now locked at the latest before the fastening means 5 are released. During the release of the fastening means 5, the receiving means 4 is now held more by the locking means 6 in the assembly room 11. So that no water can penetrate into the assembly room at this stage or more precisely up to this stage of disassembly of the rudder propeller ship propulsion system from the ship 2, sealing means 16 are provided and are active between the ship 2 and the rudder propeller ship propulsion system 1, in particular its receiving means 4.

Even if it is basically possible to provide such locking means 6, which are locked manually, it is nevertheless preferable if the locking means 6 can be actuated/driven by remote control and/or locked automatically, e.g., mechanisms (not shown).

The fastening means 5 contain, in the exemplary embodiment discussed here, connecting screws 17, one of which is shown in FIG. 6 in an enlarged view as an example. These connecting screws 17 can be loosened manually by workers without problems since the locking means 6 hold the receiving means 4 securely and by the sealing means 16 also tightly in the assembly room 11. The corresponding work for loosening the fastening means 6 can therefore be carried out simply, quickly and safely. In this case, it should be noted that the fastening means 5, as opposed to the locking means 6, guarantee an especially durable connection capable of absorbing great forces between the ship's hull 12 and the rudder propeller ship propulsion system 1 and its receiving means 4.

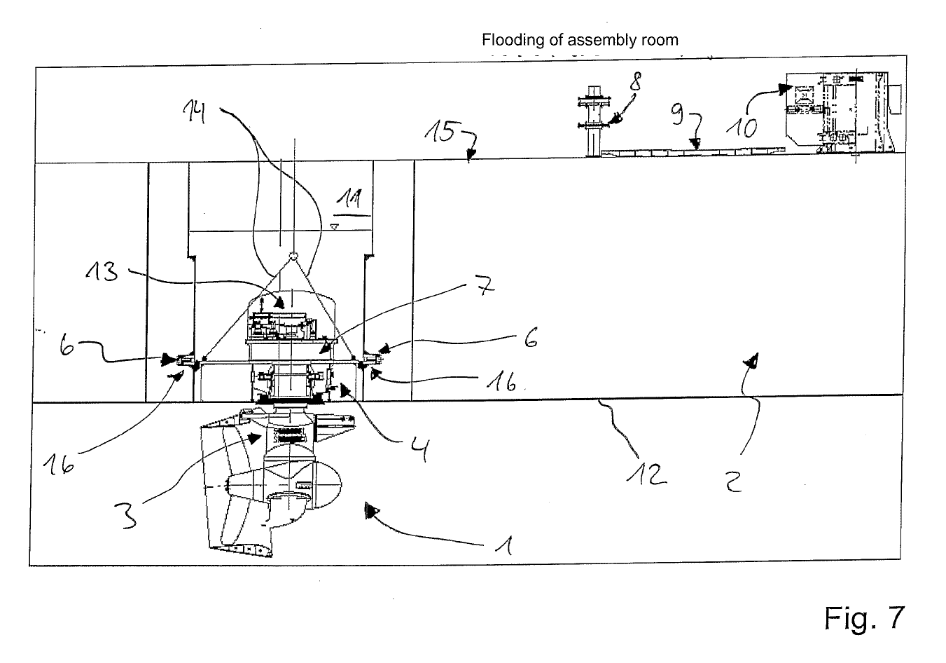

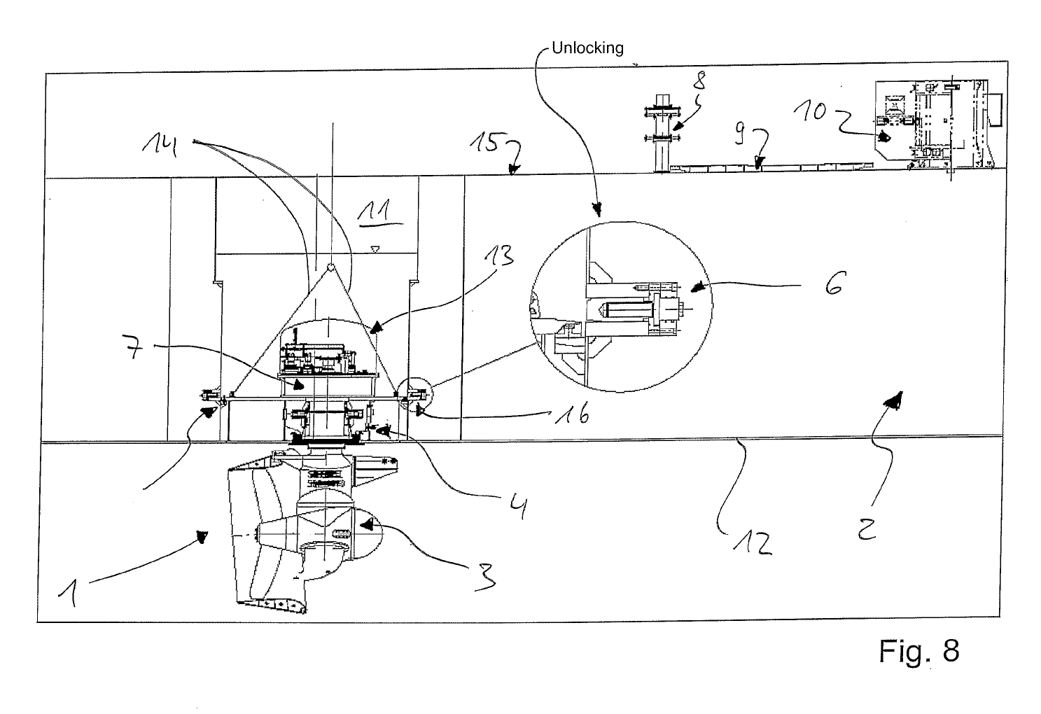

According to the view in FIG. 7, the assembly room 11 is flooded next and then, as is illustrated in FIG. 8, the unit from the receiving means 4 with rudder propeller 3 suspended below it and control gear 7 mounted above it, which, in the direction of the receiving means 4 or with it, is covered or encapsulated watertight by the cover 13, is suspended from above on the cable 14, so that now the locking means 6 can also be released, which is especially actuated by remote control and/or carried out automatically in a simple, fast and safe manner, e.g., by means of a mechanism (not shown).

It should be noted that the locking means 6 only need to be configured and designed in such a way that it holds the unit from receiving means 4 with rudder propeller 3 suspended below it and control gear 7 mounted above it, which is covered or encapsulated watertight to or with the receiving means 4 by the cover 13 during the disassembly—and in a similar manner also during the assembly—of the rudder propeller ship propulsion system 1 securely in the assembly room 11, until the fastening means 5 are released and said unit is securely suspended on the cables 14. In this case, it is advantageous for the locking means 6 to be available independently of a crane (not shown) and anywhere in the world where a maintenance and repair requirement for the rudder propeller ship propulsion system 1 may occur. The holding of the said unit with the locking means 6 is, as opposed to the alternative holding of this unit with a crane (or optionally with several cranes) also independent of environmental factors, such as, e.g., weathering and also of personnel for crane operation as well as space requirement and costs (such high-performance cranes cost a lot of money depending on their service life). In addition, the locking means 6 can be combined with the sealing means 16 already necessary anyhow, resulting in structural and functional savings and other advantages.

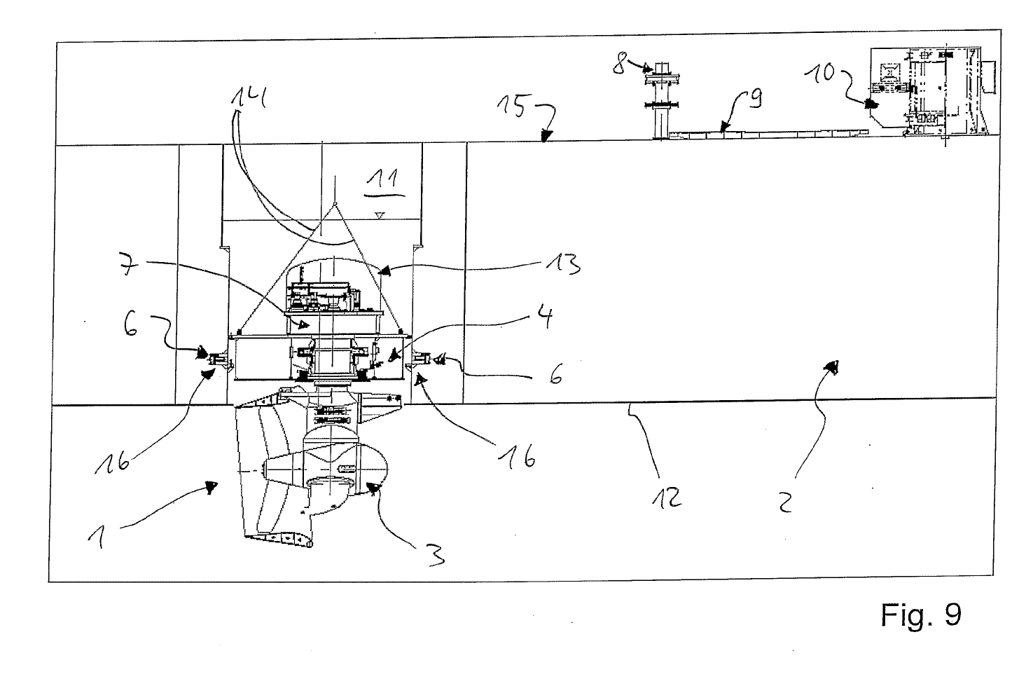

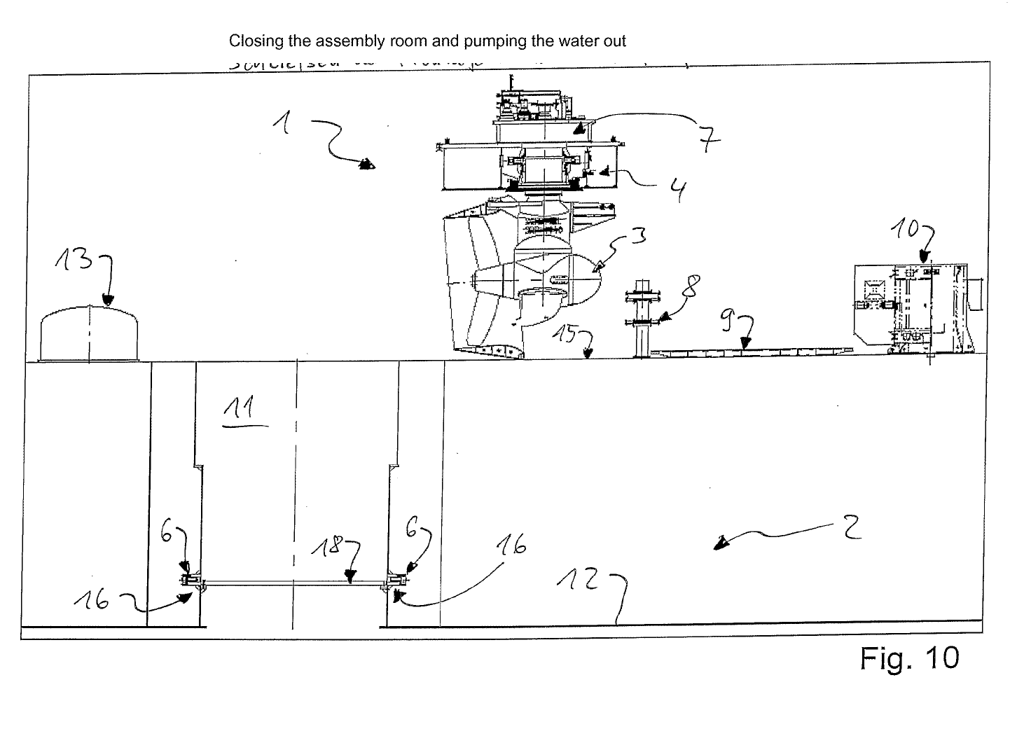

FIG. 9 shows how the unit from receiving means 4 with rudder propeller 3 suspended below it and control gear 7 mounted above it, which is covered or encapsulated watertight to or with the receiving means 4 by the cover 13, is lifted from above on cables 14 by the crane (not shown) out of the assembly room 11 of the ship 2. To carry out work on this unit it is placed on the deck 15 of the ship 2, as shown in FIG. 10. The assembly room 11 is sealed off by a sealing plate 18 at the site of the receiving means 4 after removal of the rudder propeller ship propulsion system 1 from the ship 2 and advantageously held by the locking means 6, wherein the sealing means 16 also advantageously provide the necessary sealing. Thus, it becomes clear as another great advantage of the locking means 6, which not only ensure the locking of the receiving means 4 during the release of the fastening means 5, which under some conditions would also be possible with a crane at a corresponding cost, but rather also for the entire duration of the overhauling, maintenance and/or repair of the rudder propeller ship propulsion system 1 or its individual components keeps the sealing plate 18 sealed off in the assembly room 11 of the ship 2. From the assembly room 11, then the water contained in it can also be pumped out without problems, so that work is also possible in the assembly room 11.

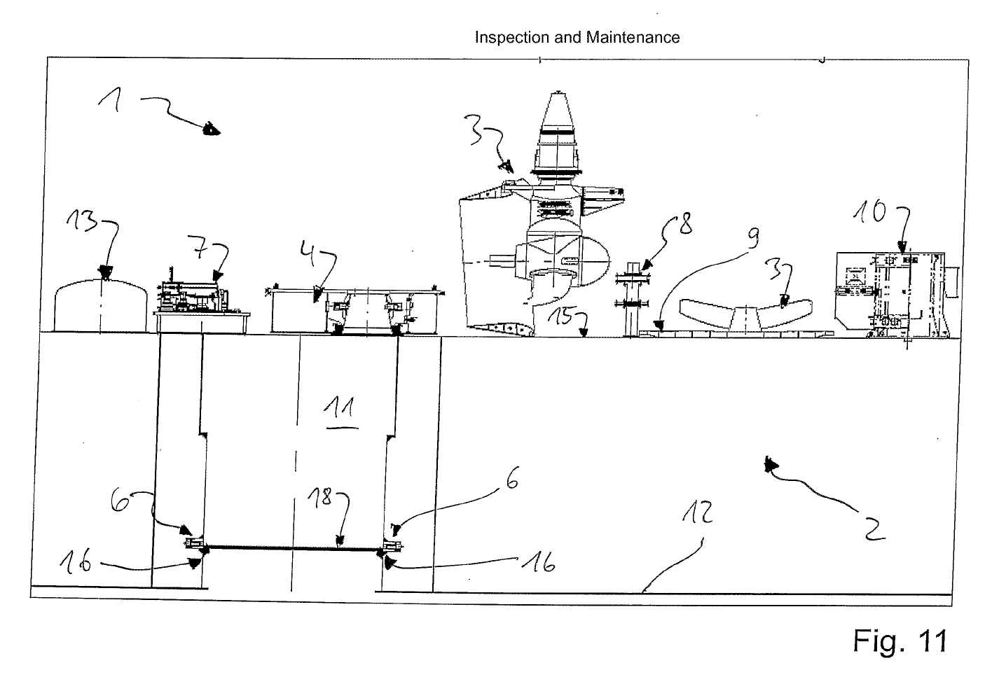

FIG. 11 illustrates that the unit from receiving means 4 with rudder propeller 3 suspended below it and control gear 7 mounted above it, which is covered or encapsulated watertight to or with the receiving means 4 by the cover 13 can then on deck 15 be broken down into its individual components rudder propeller 3, receiving means 4 and control gear 7, so that the necessary work can be carried out easily and quickly.

The disassembly process explained above by way of example has to be carried out again but in reverse order for the purpose of assembly—initial assembly or re-assembly after work has been performed.

The present invention is represented only as an example based on the exemplary embodiments in the specification and in the drawing and is not limited to them but rather includes all variants, modifications, substitutions and combinations that the person skilled in the art can derive from the present documents, in particular, within the scope of the claim and the general statements in the introduction to this specification as well as in the description of the exemplary embodiments and is able to combine by using his specialized knowledge and the state of the art. In particular, all of the individual features and possible embodiments of the present invention and its exemplary embodiments may be combined.

1. Rudder propeller ship propulsion system with a rudder propeller containing an underwater housing and installed and/or mounted on a receiving means that is detachably fastened by fastening means on or in a ship's hull, further comprising locking means for the receiving means, which are separate with respect to the fastening means, and wherein the receiving means can be locked and unlocked on or in a ship's hull by means of the locking means even when the fastening means are released.

2. Ship equipped with a rudder propeller ship propulsion system containing a rudder propeller with an underwater housing, which rudder propeller is installed and/or mounted on a receiving means that is detachably fastened by fastening means on or in a ship's hull, further comprising locking means for the receiving means, which are separate with respect to the fastening means, and wherein the receiving means can be locked and unlocked on or in a ship's hull by means of the locking means even when the fastening means are released.

3. Assembly and disassembly process for a rudder propeller ship propulsion system on or in a ship with a rudder propeller containing an underwater housing and installed and/or mounted on a receiving means that is detachably fastened on or in a ship's hull by means of fastening means, further comprising providing locking means for the receiving means, which are separate with respect to the fastening means, and wherein the receiving means can be locked or unlocked on or in a ship's hull even when the fastening means are released, in which process for disassembly of the rudder propeller ship propulsion system of or from a ship starting from a state in which the receiving means is fastened by the fastening means on or in the ship and is locked by the locking means on or in the ship, first the fastening means are released, so that the receiving means is only held on or in the ship by the locking means and then the locking means are unlocked free of manual work at the locking sites between receiving means and ship so that the receiving means and rudder propeller can be removed.

4. Rudder propeller ship propulsion system in accordance with claim 1 further comprising a main motor of the rudder propeller ship propulsion system which is removable by means of a framing means in a ship equipped with the rudder propeller ship propulsion system and installable in an upward direction, wherein the main motor and the framing means are separated and can be removed in this order in succession from the ship.

5. Rudder propeller ship propulsion system in accordance with claim 1 further comprising
a control gear of the rudder propeller ship propulsion system which is installable or installed so as to be removable in a ship equipped with the rudder propeller ship propulsion system and especially in the upward direction, and between the main motor of the rudder propeller ship propulsion system and the receiving means, wherein it is especially preferred for the control gear of the rudder propeller ship propulsion system to be removable from the ship together with the receiving means and
a cover for the control gear of the rudder propeller ship propulsion system in order to be installed sealingly over the control gear on the receiving means before the unlocking of the locking means.

6. Rudder propeller ship propulsion system in accordance with claim 1, further comprising an elastic shaft for transmitting movement and torque between a main motor of the rudder propeller ship propulsion system and a control gear of the rudder propeller ship propulsion system, said elastic shaft being installable and removable after removal of the main motor and before removal of the control gear, said elastic shaft being removable in an upward direction.

7. Rudder propeller ship propulsion system in accordance with claim 2 wherein the locking means are unlocked during the operation of the ship and are only locked for disassembly of the rudder propeller ship propulsion system at the latest before the release of the fastening means.

8. Rudder propeller ship propulsion system in accordance with claim 2 further comprising sealing means provided between the ship and rudder propeller ship propulsion system, in particular its receiving means and are active especially until the release of the locking means in order to keep water from passing the receiving means into the ship's interior when the rudder propeller ship propulsion system has been installed.

9. Rudder propeller ship propulsion system in accordance with claim 2 wherein an assembly room for the rudder propeller ship propulsion system in the ship is flooded before or after the unlocking of the locking means.

10. Rudder propeller ship propulsion system in accordance with claim 1 wherein said receiving means comprises a sealing plate installable in a sealing manner at the site of the receiving means after removal of the rudder propeller ship propulsion system from the ship in an assembly room of the rudder propeller ship propulsion system, and water is especially preferably pumped out of the assembly room of the rudder propeller ship propulsion system in the ship after installation of the sealing plate.
